(19) United States
(12) Patent Application Publication
(10) Pub. No.: US 2004/0074863 A1
(43) Pub. Date: Apr. 22, 2004

(54) Crown closure with curled lower edge

(76) Inventors: Christopher Paul Ramsey, Oxfordshire (GB); Sylvia Maria Haglund, Oxfordshire (GB)

Correspondence Address: Vincent L Ramik, Diller Ramik & Wight, Suite 101, 7345 McWhorter Place, Annandale, VA, 22003, US

(21) Appl. No.: 10/469,927

(22) PCT Filed: Feb. 12, 2002
(86) PCT No.: PCT/EP02/01527

(30) Foreign Application Priority Data
Mar. 6, 2001 (EP) 01302029.2

(51) Int. Cl. B65D 41/12; B67B 3/18

(52) U.S. Cl. 215/327; 215/328; 53/488

(57) ABSTRACT

A crown closure (12) having a curled lower edge is described. The curled crown (12) is typically formed from double reduced steel which is 35% thinner gauge than that used for conventional fluted crowns. The crown is also described in combination with a standard glass bottle. The curl (15) of the crown (12) tucks under the capping bead of the bottle so as to achieve standard pressure requirements. Added benefits of this configuration are not only the concealment of the edge of the closure but also the distinctive appearance of the product.

This invention relates to a crown closure and, in particular to a crown closure for use in the capping of bottles and the combination of a crown closure with a bottle having an outwardly extending capping bead.

Crown closures (hereinafter alternatively referred to simply as “crowns”) are long established for the capping of glass and, more recently, plastics bottles. They traditionally consist of a top panel lined with a sealing compound, and a peripheral skirt. A corrugation die provides fluting along the length of the skirt and the crown is crimped onto a bottle to close it. The crown is removed with a traditional bottle opener.

However, the metal of traditional crowns is relatively thick in comparison with that of other metal closures so that known crowns are inherently costly in material usage. The edge of the crimped and fluted crown is exposed so that traditional steel crowns are prone to rusting. The raw edge can also cause a safety hazard if the crown is not handled or disposed of correctly.

According to the present invention, there is provided a metallic crown closure including a centre panel, and a peripheral skirt portion depending downwardly therefrom, the distal end of the skirt portion being curled outwardly to form a curl portion, the curl portion comprising at least 180° of material when viewed in cross section and being 0.5 to 2 mm in diameter.

In a preferred embodiment which hides any exposed edge of metal on the crown, the curl portion may comprise around 270° of material. Conventionally, the degree of curl is measured from the point at which the side of the skirt portion deviates from being linear. The curl may be ideally 1.5 mm or less in diameter.

The invention also provides, in combination, a bottle having a neck which includes an outwardly extending capping bead, and the crown closure described above, fitted over the neck of the bottle with its skirt portion around the neck finish and the curl substantially underneath the capping bead such that the outer diameter of the curl of the fitted crown is substantially the same as the outer diameter of the skirt portion.

The Applicant has found that up to 35% thinner gauge material can be used for the crown closure of the present invention whilst still achieving the same pressure performance as that of standard fluted crowns. It is believed that this is due to the build up of metal layers in the curl region. As the curl will, after application of the crown closure to a bottle, be tucked in under the bottle finish, the thickness of metal under the bottle finish is two to three times that of the crown side wall and top panel. The double/triple metal thicknesses under the bottle finish enables the crown closure to withstand forces in this region during processing or due to carbonated product within the bottle.

The metallic crown closure is conveniently formed of steel, which may be coated with a polymer material. The crown may conveniently be formed of a double reduced steel such as “DR 580”. Double reduced steel is stiffer than the single reduced steel used for conventional crowns.

Preferably, the double reduced steel of the crown closure is in the range of 0.1 mm to 0.2 mm gauge, in contrast with 0.235 mm gauge single reduced steel which is required for conventional crowns.

A bottle closed with the crown closure of this invention not only creates a distinctive appearance, but the curl portion also serves to maintain the cut edge of the crown away from the surface of the bottle. Thus, even if rust starts to form on the edge of a steel closure, e.g. in hot and humid climates such as the Far East, this rust is not deposited on to the bottle surface when the closure is removed.

The use of alternative materials such as aluminium is also possible but probably is not advantageous due to higher raw material costs.

The weight of the crown shell (that is, without any gasket insert) is typically from 1.3 g to 1.54 g and, when applied to a bottle, the crown is ideally less than 6 mm in height. The formation of a curl does not require any extra metal from that which is required for the shell of a traditional crown, which ranges from 1.8 g to 2.3 g in weight, typically weighing 2.02 g. The traditional crown is usually 6 mm in overall height after crimping onto the bottle. Ideally the curl is small in diameter so as to avoid collapse of the curl during application to a bottle, but large enough to be able to move radially inwards under a capping bead on the bottle. Furthermore, the crown must be able to withstand pressures which arise when containing pressurised products or where pasteurisation is required.

In one embodiment, the curl may be petaloid in structure with one or more reformed regions around its circumference which are limited to the height of the curl itself and do not extend up the plain side wall of the crown. As a result, whether the crown is reformed or not, the relatively plain skirt portion (as opposed to the corrugated skirts used in conventional crowns) may be used for printing decorative or promotional material.

When the crown is applied to a bottle, the curl comprises at least 180°, although it is preferable that the exposed edge is hidden for safety purposes so that the curl is around 270°, and preferably 360° of material when viewed in cross section.

The crown closure of the invention has significant functional advantages. For example, the curled skirt has several advantages over the conventional corrugated skirt, not least in that it provides less of a safety hazard if discarded inappropriately. Furthermore, the conventional uncurled and corrugated crown closures are prone to a problem known as ‘dusting’, in which crowns contact each other during transit and the sharp edges of the crowns chip off small particles of coating materials, producing dust particles which can cause contamination.

In addition, contact between conventional crowns can lead to damage to decoration and/or lacquer damage (internal or external) which is required for protection from corrosion. The curled periphery of the crowns of the present invention helps to avoid this problem.

As the crown of the invention is lighter that the traditional crown, it is clear that weight savings are made in the packaging of crowns for transport.

According to a further aspect of the invention there is provided a method of capping a bottle with the curled crown of the present invention as described above, the method comprising: locating the crown over the neck of a bottle, the neck of the bottle including an outwardly extending capping bead; and reforming the crown to move at least a part of the curl under the capping bead, thereby securing the crown onto the neck of the bottle.

The method may further comprise tightening the curled edge of the crown by distortion from its original shape to, for example, a polygonal shape during capping of the bottle.

The invention will now be further described by way of example only, with reference to the drawings, in which:

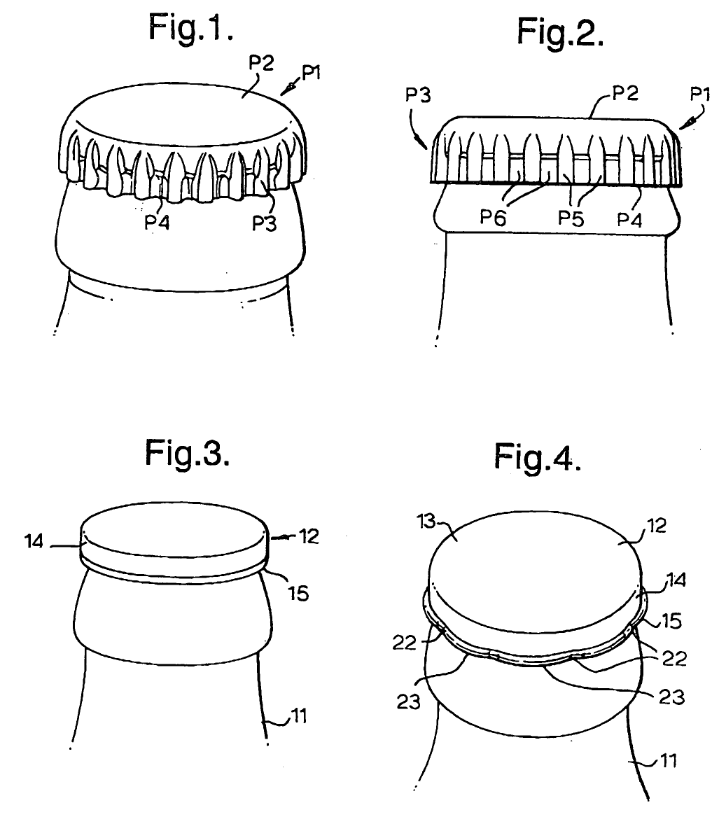

FIG. 1 is perspective view of a prior art crown closure, applied to the neck of a bottle;

FIG. 2 is a side view of a prior art crown closure, applied to the neck of a bottle;

FIG. 3 is a perspective view of a first embodiment of the crown of the present invention, applied to the neck of a bottle;

FIG. 4 is a perspective view of the embodiment FIG. 3, applied to the neck of a bottle and reformed;

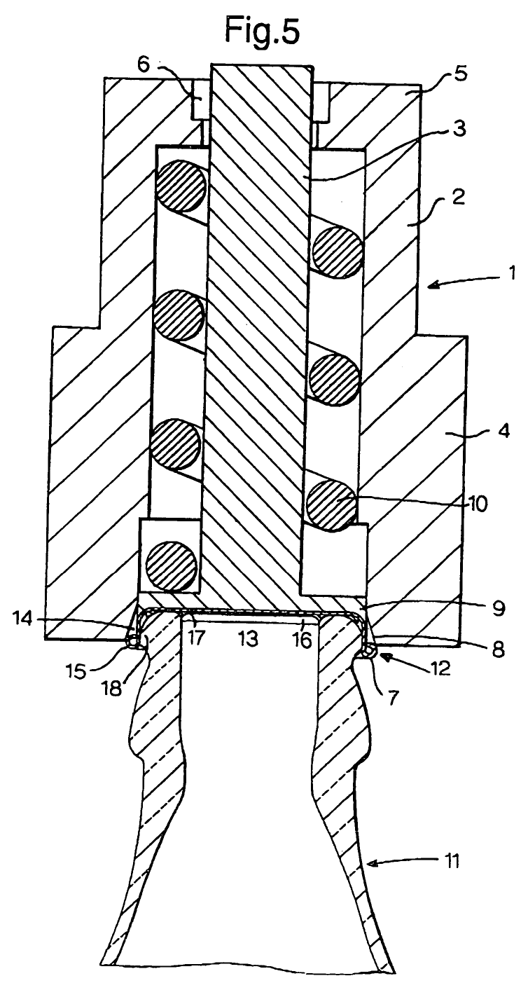

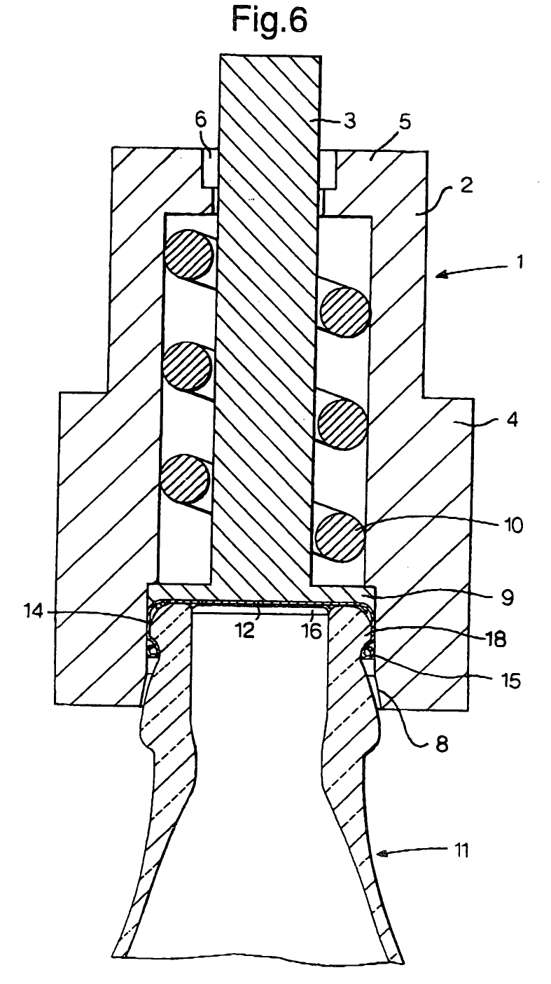

FIG. 5 is a schematic sectional view of capping apparatus for capping a bottle with the crown of the present invention, shown in a first position;

FIG. 6 is a schematic sectional view of the apparatus of FIG. 5, shown in a second position;

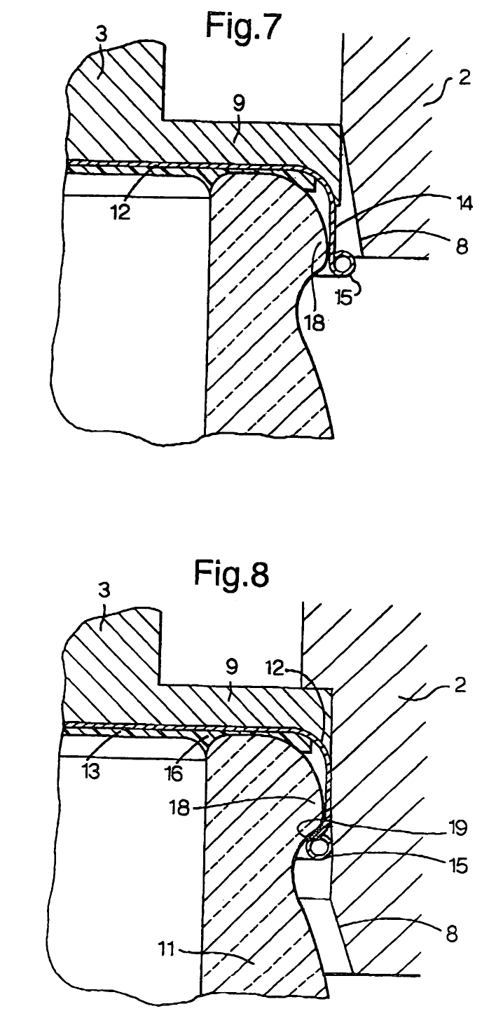

FIG. 7 is an enlarged view of a part of FIG. 5;

FIG. 8 is an enlarged view of a part of FIG. 6;

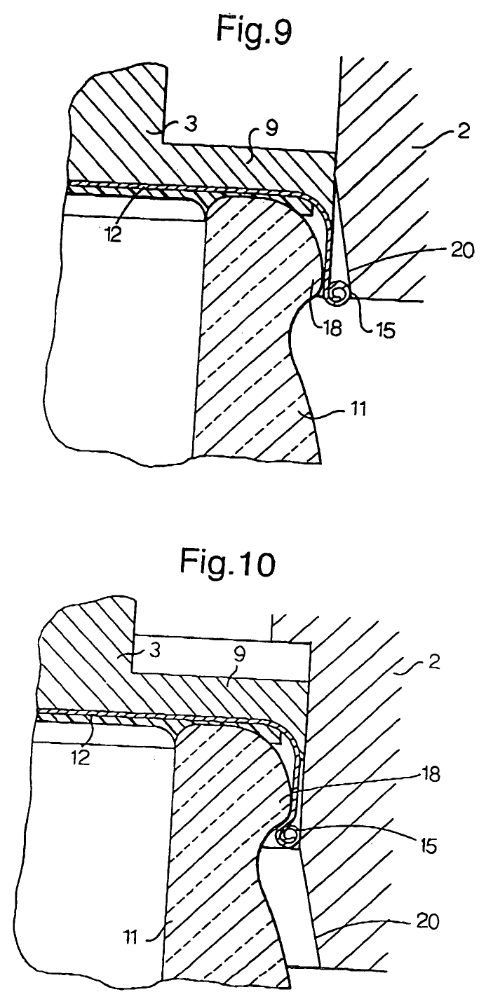

FIG. 9 is a schematic sectional view of an alternative apparatus for capping a bottle;

FIG. 10 is a schematic sectional view of the apparatus of FIG. 9, shown in a second position; and

FIG. 11 is a schematic of different degrees of curl.

FIGS. 1 and 2 show a prior art crown closure P1, typically of 0.235 mm single reduced steel, applied to a bottle and comprising a centre panel P2 and depending skirt P3. The skirt is approximately 6 mm in height and has an exposed lower edge P4. The centre panel is typically 26.5 mm in diameter. A series of alternate ribs P5 and flutes P6 are formed around the whole circumference of the skirt, with the ribs P5 extending over the majority of the height of the skirt P3 so that the skirt has no or at best limited plain surface portions.

FIGS. 3 and 4 are perspective views of the crown closure 12 of the present invention, as applied to a bottle 11, without and with reforming respectively. The crown can be seen in side section in “apparatus” FIGS. 5 to 9 and FIG. 11.

The crown 12, which is formed from 0.12 to 0.2 mm DR 580 double reduced steel, typically 0.16 mm gauge, comprises a centre panel 13, typically 26.5 mm in diameter, and a peripheral skirt 14 depending therefrom. The skirt 14 is at most 6 mm in height and terminates in an outer curl 15.

The curled crown of FIGS. 3 and 4 uses a shell of 1.4 g, which is significantly less weight than the weight of the conventional crown of FIGS. 1 and 2 (2.02 g). It can therefore be seen that the thinner gauges used for the curled crown of the present invention present major cost savings. Even the upper end of the gauge range used for the curled crown (i.e. 0.2 mm) is 35% thinner than the 0.235 mm gauge used for conventional crowns. Furthermore, a 0.2 mm curled crown of the present invention and a 0.235 mm conventional crown have been demonstrated to have the same pressure performance when each was applied to a standard glass bottle finish.

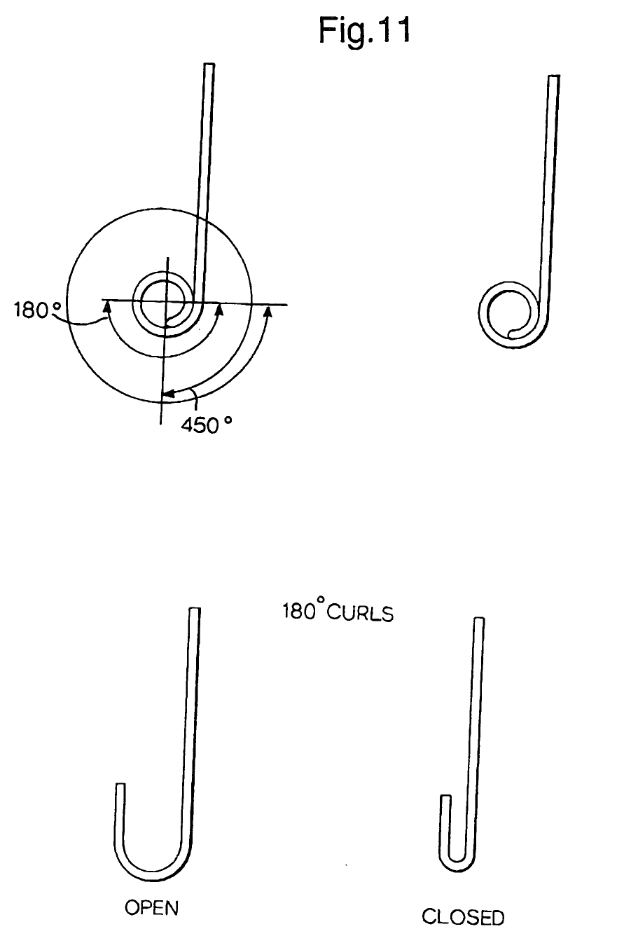

As shown in side section in FIG. 7, for example, the outer curl 15 comprises a complete curl including at least 270° of material (see also FIG. 14). An overcurl of up to 180° may be used to avoid uncurling (exposure of the raw metal edge) during application, although in practice this has, to date, not been found to be essential. A gasket of sealing compound 16, typically a polymeric material, is attached to the underside of the centre panel between the panel and an annular top surface 17 of the bottle. The bottle also includes an annular capping bead 18, and the outer curl 15 lies adjacent the capping bead 18.

A curl diameter of between 0.5 and 1.5 mm is recommended for applying the curled crown to the bottle where pasteurisation is required or where the product to be contained in the bottle is pressurised. The curl provides a build up of thicknesses under the bottle finish, thereby allowing thinner gauge materials to be used for the curled crown of the present invention. Although the top panel of the crown is subject to the same forces, the panel-can be stiffened by a variety of techniques not available around the neck finish, such as by providing a concavity in the centre panel, embossing etc.

It can be seen that the crown closure 12 when attached to bottle 11 has a distinctive slimline appearance. Furthermore, the edge 19 of the closure is hidden so as not to pose a danger to users, and yet it is also maintained in a position away from the surface of the bottle so that if rust starts to form on the edge 19, it is not in contact with the bottle 11.

The crown of FIG. 4 has a petaloid structure with alternating reformed and plain areas. Although the crown shown in FIG. 4 has regularly spaced reformed “petals” around its circumference, these petals could vary in number and/or position as desired.

Whether the skirt has a petaloid or plain structure, both embodiments shown have significant smooth skirt portions. This makes printing or other features possible on the skirt which would be lost and/or distorted by the reforming of the conventional crown of FIGS. 1 and 2. This is an advantage where the product to be sold will be stacked on supermarket shelves, with the top panel of the crown not visible to the customer.

Referring now to FIG. 5, an apparatus for capping a bottle 11 with the crown 12 of the present invention is shown generally at 1. The apparatus 1 comprises a capping tool 2 reciprocal on a central shaft 3. The capping tool is generally cup shaped and comprises a cylindrical side wall 4 depending from an upper end 5. A central hole 6 allows the shaft 3 to pass therethrough. The lower end of the tool is open, the opening 7 being provided with a tapered infeed section 8. The shaft 3 has a piston plate 9 at the lower end thereof and a spring 10 is constrained between the piston plate and the upper end 5 of the tool.

For capping the bottle 11, the bottle is first presented to the apparatus 1, with the crown closure 12 placed thereon. To attach the crown 12 to the bottle 11, the piston plate 9 holds the crown in position, and the capping tool 2 is lowered on the central shaft from the position shown in FIGS. 5 and 7 to that shown in FIGS. 6 and 8. As the capping tool 2 is lowered, the tapered infeed section 8 progressively contacts the outer curl 15, moving it downwardly and inwardly to the position shown in FIG. 8, in which it lies under the capping bead 18. During this movement the outer curl 15 may be partially uncurled, but remains curled to the extent that at least 270° of material is contained within the curl. When such uncurling has not taken place, the overcurl could be reduced to zero or near zero with corresponding cost savings in cut edge.

FIGS. 9 to 11 show an alternative embodiment of apparatus for applying the crown of the present invention to a bottle, in which features similar to those in FIGS. 5 to 8 are designated with like reference numerals. The apparatus is suitable for capping crown closures 12 in which the outer curl 15 is provided with substantially more than one turn of material, in this case approximately 1¼ turns (450°) of metal. The capping tool 2 differs from that described previously in that the tapered infeed section 8 is castellated, and has inwardly extending segments 20 separated by land portions 21. This tool is shown in FIG. 10.

The operation of the apparatus is similar to that previously described, with the capping tool 2 being lowered on the central shaft 3 as shown in FIG. 11. Prior to capping, the curl 15 extends out beyond the diameter of the skirt. The segments 20 contact the outer curl 15 so as to urge it under the capping bead 18 at those positions around its circumference in which contact is made. The result is the petaloid structure of FIG. 4, as described above, with the reformed petals limited to the curl itself. This contrasts with conventional crowns on which full height flutes are formed prior to application.

The segments 20 of the tool as shown in FIG. 10 could be limited to only part of the circumference of the tool to provide product differentiation. Similarly, the number and spacing of the “petals” can be varied if the customer so requires, simply by changing the crimping ring, which is a low cost item.

In both of the above embodiments, the crown closure 12 may be removed from the bottle 11 using a conventional bottle opener. In the arrangement of FIG. 4, the plain areas 23 provide particularly good sites on which the bottle opener can be employed. Clearly, being a crown closure, the evidence of a bottle opener on the top panel is an indication that tampering has occurred.

The schematic of FIG. 14 demonstrates how the curl angle is measured and what is meant by an “open” or “closed” curl.

1. A metallic crown closure for use with a bottle having a neck which includes an outwardly extending capping bead, the closure including a centre panel, and a peripheral skirt portion depending downwardly therefrom, the distal end of the skirt portion being curled outwardly to form a curl portion and the curl portion comprising at least 180° of material when viewed in cross section;
characterised in that:
the curl portion is 0.5 to 2 mm in diameter, such that, when the crown is fitted over the neck of the bottle with its skirt portion around the neck finish and the curl substantially underneath the capping bead, the outer diameter of the curl of the fitted crown is substantially the same as the outer diameter of the skirt portion.

2. A crown according to claim 1, which is formed of steel and, optionally, coated with a polymer material.

3. A crown according to claim 2, which is formed of a double reduced steel such as “DR 580, which is in the range of 0.1 mm to 0.2 mm gauge.

4. A crown according to any one of claims 1 to 3, in which the diameter of the centre panel is of the order of 26.5 mm.

5. A bottle having a neck which includes an outwardly extending capping bead and fitted with the crown of any one of claims 1 to 4, in which the crown is fitted over the neck of the bottle with its skirt portion around the neck finish and the curl substantially underneath the capping bead such that the outer diameter of the curl of the fitted crown is substantially the same as the outer diameter of the skirt portion.

6. A bottle according to claim 5, in which the crown applied thereto is less than 6 mm in height.

7. A bottle according to claim 5 or claim 6, in which the curl of the crown applied to the bottle includes one or more reformed regions around its circumference which are limited to the height of the curl itself and do not extend up the plain side wall of the crown.

8. A bottle according to any one of claims 5 to 7, in which the curl of the crown applied to the bottle comprises at least 270° of material when viewed in cross section.

9. A method of capping a bottle with the crown of any one of claims 1 to 8, comprising:
locating the crown over the neck of a bottle, the neck of the bottle including an outwardly extending capping bead; and
reforming the crown to move at least a part of the curl under the capping bead, thereby securing the crown onto the neck of the bottle.

10. A method according to claim 9, further comprising tightening the curled edge of the crown during capping of the bottle by distortion from its original circular shape to a polygonal shape.
